(19) United States
(12) Patent Application Publication
(10) Pub. No.: US 2008/0117369 A1
(43) Pub. Date: May 22, 2008

(54) Liquid crystal display panel with step-shaped spacers located at thin film transistor substrate thereof

(75) Inventors: Hsi-Chien Chen, Miao-Li (TW); Hung-Sheng Cho, Miao-Li (TW); Kun-Hsing Hsiao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/986,394

(22) Filed: Nov. 21, 2007

(30) Foreign Application Priority Data
Nov. 21, 2006 (TW) 95142992

(51) Int. Cl. G02F 1/1339; G02F 1/1335

(52) U.S. Cl. 349/106; 349/155

(57) ABSTRACT

An exemplary liquid crystal display panel (4) includes a first substrate (41), a second substrate (43) disposed generally opposite to the first substrate, and a plurality of step-shaped spacers. The first substrate includes a plurality of gate lines (411), a plurality of date lines (412), and a plurality of thin film transistors (414). The second substrate includes a smooth surface facing the first substrate. The step-shaped spacers are located at the first substrates for supporting the second substrate.

### FIELD OF THE INVENTION

The present invention relates to liquid crystal display panels, and more particularly to a liquid crystal panel with step-shaped spacers located at a thin film transistor substrate of the liquid crystal display panel.

### GENERAL BACKGROUND

Liquid crystal displays (LCDs) have the advantages of portability, low power consumption, and low radiation. Therefore, liquid crystal displays have been widely used in common daily life. Typically, a liquid crystal display includes a liquid crystal display panel, which has a thin film transistor (TFT) substrate and a color filter substrate.

FIG. 5 is a side plan view of a conventional liquid crystal display panel. The liquid crystal display panel 1 includes a first substrate 11, a second substrate 12 disposed generally opposite to the first substrate 11, a liquid crystal layer 13 located between the first and second substrates 11, 12, and a plurality of ball-shaped spacers 14. The spacers 14 are provided between the first and second substrates 11, 12 for supporting the first substrate 11. Thereby, the first and second substrates 11, 12 define a cell gap (not labeled) therebetween for receiving the liquid crystal layer 13.

During the process of manufacturing the liquid crystal display panel 1, the ball-shaped spacers 14 are generally sprayed at the second substrate 12. That is, the ball-shaped spacers 14 may not locate at the second substrate 12 uniformly, thus a distance between the first and second substrates 11, 12 may vary with the density of the spacers 14. For example, if few or no spacers 14 are located at certain portion of the liquid crystal display panel 1, the distance between the first and second substrates 11, 12 at the portion may decrease without supporting of the spacers 14. As a result, liquid crystal display panel 1 may generate light leakage at the portion.

Referring to FIG. 6, this is a side, cross-sectional view of another conventional liquid crystal display panel. The liquid crystal display panel 2 includes a TFT substrate 21, a color filter substrate 22 disposed generally opposite to the TFT substrate 21, and a liquid crystal layer 23 sandwiched between the TFT and color filter substrates 21, 22.

The TFT substrate 21 includes a plurality of date lines (not shown), a plurality of gate lines (not shown), and a plurality of TFTs (not shown). Due to different manufacture processes, the TFTs are generally higher than the gate lines and the date lines. The color filter substrate 22 includes a color filter layer 25, a coating layer 241, and a common electrode layer 240 disposed in that order from top to bottom. A plurality of cylindrical spacers 24 is formed at the common electrode layer 240 corresponding to positions of the gate lines, the date lines, and the TFTs. The cylindrical spacers 24 are provided for supporting the color filter substrate 22. In order to keep a consistent distance between the TFT and color filter substrates 21, 22, the cylindrical spacers 24 have different heights corresponding to the gate lines, the date lines, and the TFTs. That is, a height of the cylindrical spacers 24 corresponding to the gate lines and the date lines is higher than that of the cylindrical spacers 24 corresponding to the TFTs.

During the process of manufacturing the liquid crystal display panel 2, the color filter substrate 22 is attached to the TFT substrate 21 with the cylindrical spacers 24 contacting corresponding gate lines, date lines, and TFTs. However, it is difficult for the cylindrical spacers 24 to accurately align with the gate lines, the date lines, and the TFTs. Once the cylindrical spacers 24 are misaligned, the cylindrical spacers 24 corresponding to the gate lines or the data lines may disposed at the TFTs at certain portion. As a result, the distance between the TFT substrate 21 and the color filter substrate 22 may increase at the portion. Therefore, the liquid crystal display panel 2 may generate light leakage at the portion.

What is needed, therefore, is a liquid crystal display panel that can overcome the above-described deficiencies.

### SUMMARY

A liquid crystal display panel includes a first substrate, a second substrate disposed generally opposite to the first substrate, and a plurality of step-shaped spacers. The first substrate includes a plurality of gate lines, a plurality of date lines, and a plurality of thin film transistors. The second substrate includes a smooth surface facing the first substrate. The step-shaped spacers are located at the first substrates for supporting the second substrate.

A liquid crystal display panel includes a thin film transistor substrate, a color filter substrate disposed generally opposite to the thin film transistor substrate, and a plurality of step-shaped spacers. The step-shaped spacers are located at the thin film transistor substrate for supporting the second substrate. The thin film transistor substrate and the color filter substrates define a consistent cell gap therebetween.

Other novel features and advantages will become more apparent from the following detailed description when taken in conjunction with the accompanying drawings.

### BRIEF DESCRIPTION OF THE DRAWINGS

FIG. 1 is an abbreviated, exploded, isometric view of a liquid crystal display panel according to an exemplary embodiment of the present invention, the liquid crystal display panel including a first substrate and a second substrate.

FIG. 2 is a side, cross-sectional view of part of the first substrate taken along line II-II of FIG. 1.

FIG. 3 is a side, cross-sectional view of another part of the first substrate taken along line III-III of FIG. 1.

FIG. 4 a sectional view showing a process of combining the first and second substrates of FIG. 1.

FIG. 5 is a side plan view of a conventional liquid crystal display panel.

FIG. 6 is a side, cross-sectional view of another conventional liquid crystal display panel.

### DETAILED DESCRIPTION OF PREFERRED EMBODIMENTS

Reference will now be made to the drawings to describe the preferred and exemplary embodiments in detail.

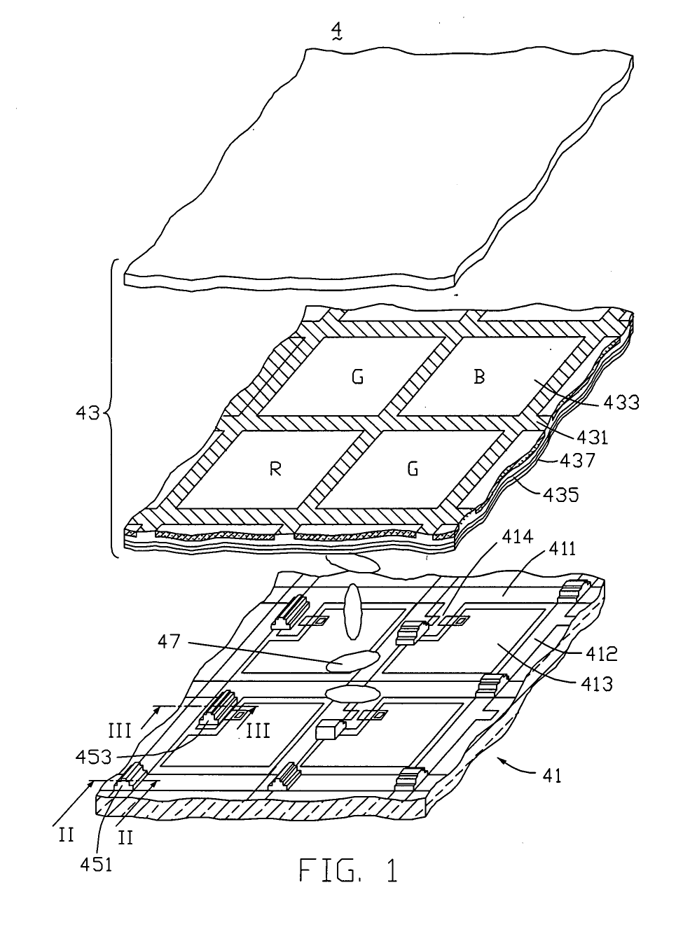

FIG. 1 is an abbreviated, exploded, isometric view of a liquid crystal display panel according to an exemplary embodiment of the present invention. The liquid crystal display panel 4 includes a first substrate 41, a second substrate 43 disposed generally opposite to the first substrate 41, a plurality of first spacers 451, a plurality of second spacers 453, and a liquid crystal layer 47. In this illustrated embodiment, the first substrate 41 is a TFT substrate, and the second substrate 43 is a color filter substrate.

The first and second spacers 451, 453 are provided between the first and second substrates 41, 43 for supporting the second substrate 43. Thereby, the first and second substrates 41, 43 define a cell gap (not labeled) therebetween for receiving the liquid crystal layer 47. Each of the first and second spacers 451, 453 has at least one step. The first and second spacers 451, 453 may be made of acrylic polymer or epoxy polymer.

The second substrate 43 includes a color filter layer (not labeled), a coating layer 435, and a common electrode layer 437 disposed in that order from top to bottom. The color filter layer includes a plurality of color filter units 433, and a black matrix 431 alternately arranged with the color filter units 433.

The first substrate 41 includes a plurality of data lines 412 parallel to each other and extending along a first direction; a plurality of gate lines 411 parallel to each other and extending along a second direction orthogonal to the first direction; and a plurality of pixel units (not labeled) defined by the intersecting gate lines 411 and data lines 412. The gate lines 411 and the data lines 412 are located at the first substrate 41 facing the black matrix 431.

Each pixel unit includes a pixel electrode 413 and a TFT 414. In each pixel unit, a gate electrode (not labeled) of the TFT 414 is electrically connected to one corresponding gate line 411, and a source electrode (not labeled) of the TFT 414 is electrically connected to one corresponding data line 412. Further, a drain electrode (not labeled) of the TFT 414 is electrically connected to one corresponding pixel electrode 413. Each of the first spacers 451 locates at an intersecting portion (not labeled) of the gate lines 411 and the data lines 412. Each of the second spacers 453 locates at one of the TFTs 414.

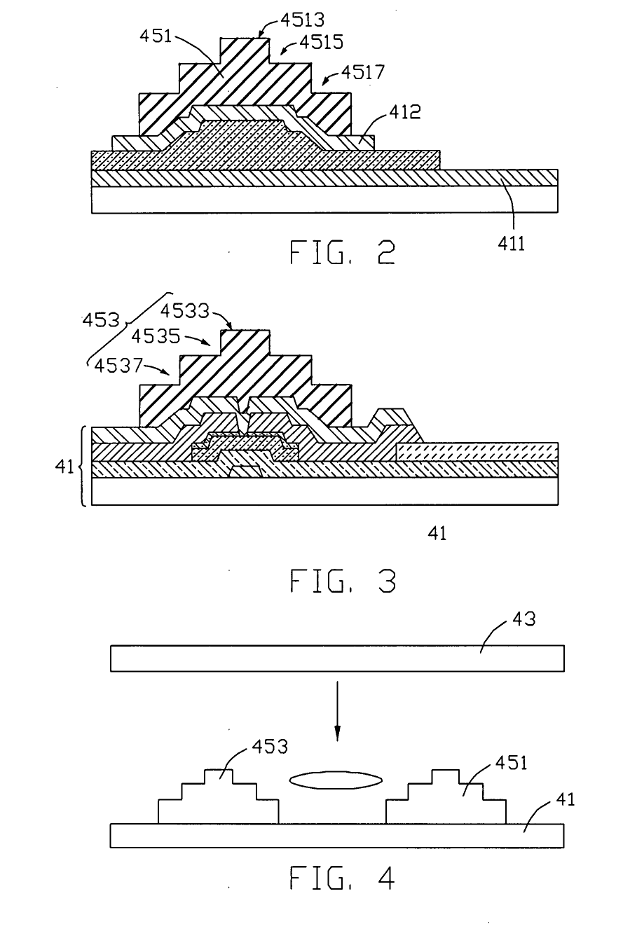

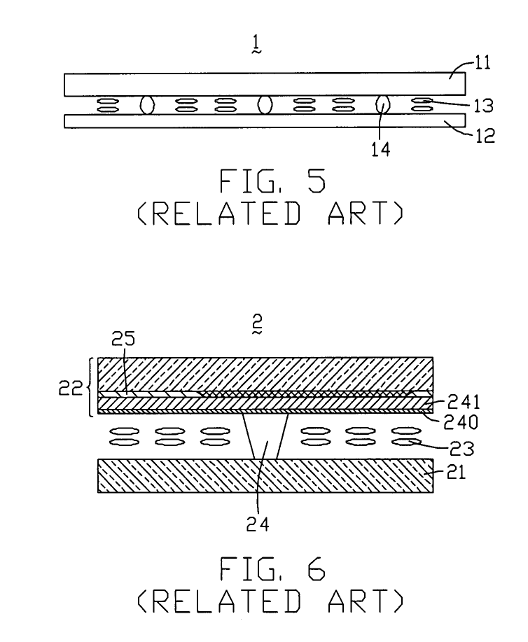

Referring also to FIG. 2, this is a side cross-sectional view of part of the first substrate 41 taken along line II-II of FIG. 1. The data line 412 crosses the gate line 411 via an insulating layer (not labeled) therebetween. Part of the data line 412, together with part of the gate line 411 and the insulating layer define a first protrusion (not labeled) at the crossing position thereof. The first spacer 451 is located on the first protrusion. Each of the first spacers 451 has a height corresponding to the first protrusion.

The first protrusion 451 has a symmetrical structure. The first protrusion 451 includes a first supporting surface 4513, a first step 4515, and a second step 4517 at one side thereof. The first and second steps 4515, 4517 are arranged in that order from top to bottom. The first supporting surface 4513 is provided for supporting the second substrate 43. The first and second steps 4515, 4517 are provided for absorbing external impact forces applied at the first spacer 451. When external impact forces are applied at the first spacer 451, the first step 4515 has a compression ratio varied in the range from 0% to 20%, the second step 4517 have a compression ratio varied in the range from 0% to 10%.

Referring also to FIG. 3, this is a cross-sectional view of another part of the first substrate 41 taken along line III-III of FIG. 1. The TFT 414 defines a second protrusion (not labeled) at the first substrate 41. The second spacer 453 is located on the second protrusion. Each of the second spacers 453 has a height corresponding to the second protrusion. A total height of the first spacer 451 and the first protrusion is equal to a total height of the second spacer 453 and the second protrusion. The second spacer 453 has a structure similar to that of the first spacer 451. The second spacer 453 includes a second supporting surface 4533, a third step 4535, and a fourth step 4537. The third and fourth steps 4535, 4537 are arranged in that order from top to bottom.

The second supporting surface 4533 is provided for supporting the second substrate 43. The third and fourth steps 4535, 4537 are provided for absorbing external impact forces applied at the second spacer 453. When external impact forces are applied at the second spacer 453, the third step 4535 has a compression ratio varied in the range from 0% to 20%, the fourth step 4537 have a compression ratio varied in the range from 0% to 10%.

Referring to FIG. 4, this is a sectional view showing a process of combining the first and second substrates 41, 43 of FIG. 1. The first and second spacers 451, 453 are located at the first substrate 41. The second substrate 43 is attached at a sealant (not shown) of the first substrate 41 for combining the first and second substrates 41, 43 together. After the second substrate 43 is attached to the first substrate 41, the first and second supporting surfaces 1513, 4533 of the first and second spacers 451, 453 contact the second substrate 43.

As detailed above, the first spacers 451 are located on the first protrusions defined by the gate lines 411, the data lines 412, and the insulating layer. The second spacers 453 are located on the second protrusions defined by the TFTs 414. Because the data lines 412, the gate lines 411, and the TFTs 414 are located at the first substrate 41 regularly, the first and second spacers 451, 453 are located at the first substrate 41 uniformly.

Furthermore, the first and second supporting surfaces 4513, 4533 of the first and second spacers 451, 453 are provided for supporting the second substrate 43. The common electrode layer 437 of the second substrate 43 is generally a smooth layer. Therefore, during the process of manufacturing the liquid crystal display panel 4, the first substrate 41 may accurately align with the second substrate 43. As a result, the distance between the first and second substrates 41, 43 is uniform. That is, the liquid crystal display panel 4 may leak fewer or no light, this increases contrast ratio of the liquid crystal display panel 4.

When external impact forces are applied at the second substrate 43, the first and second spacers 451, 453 are compressed by the impact forces, thus the first and second spacers 451, 453 function as springs. Therefore, the first and second spacers 451, 453 may absorb the impact forces applied at the second substrate 43. As a result, the liquid crystal display panel 4 avoids being damaged by the impact forces applied thereon.

The first and second spacers 451, 453 have steps. The first supporting surface 4513 of the first spacer 451 and the second supporting surface 4533 of the second spacer 453 are provided for supporting the second substrate 43. That is, the first and second spacers 451, 453 have smaller contact areas with the second substrate 43. As a result, smaller dots are generated by friction forces between the second substrate 43 and the first and second spacers 451, 453.

Various modifications and alterations to the above-described embodiments are possible. For example, the first and second spacers 451, 453 may locate at the gate lines 411 or the data lines 412. The first and second spacers 451, 453 may have domed shape.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display panel, comprising:
a first substrate comprising a plurality of gate lines, a plurality of date lines, and a plurality of thin film transistors;
a second substrate disposed generally opposite to the first substrate, the second substrate comprising a smooth surface facing the first substrate; and
a plurality of step-shaped spacers located at the first substrate for supporting the second substrate.

2. The liquid crystal display panel as claimed in claim 1, wherein each of the spacers comprises a supporting surface contacting the smooth surface of the second substrate, thereby the first and second substrates define a consistent cell gap therebetween.

3. The liquid crystal display panel as claimed in claim 1, wherein the spacers are located at the date lines.

4. The liquid crystal display panel as claimed in claim 1, wherein the spacers are located at the gate lines.

5. The liquid crystal display panel as claimed in claim 1, wherein the spacers are located at the thin film transistors.

6. The liquid crystal display panel as claimed in claim 1, wherein each of the date lines crosses one of the gate lines, the date line together with the corresponding gate line and an insulating layer therebetween define a protrusion at the crossing pointion thereof.

7. The liquid crystal display panel as claimed in claim 6, wherein the spacers comprise first spacers and second spacers, the first spacers are locate at the protrusions, the second spacers are located at the thin film transistors.

8. The liquid crystal display panel as claimed in claim 7, wherein each of the first spacers has a height corresponding to the protrusion, each of the second spacers has a height corresponding to the thin film transistor.

9. The liquid crystal display panel as claimed in claim 1, wherein a total height of the first spacer and the protrusion is equal to a total height of the second spacer and the thin film transistors.

10. The liquid crystal display panel as claimed in claim 1, wherein each of the spacers further comprises a first step and a second step arranged in that order from top to bottom.

11. The liquid crystal display panel as claimed in claim 10, wherein the first step has a compression ratio varied in the range from 0% to 20%.

12. The liquid crystal display panel as claimed in claim 10, wherein the second step has a compression ratio varied in the range from 0% to 10%.

13. The liquid crystal display panel as claimed in claim 1, wherein the spacers are made of epoxy polymer or acrylic polymer.

14. The liquid crystal display panel as claimed in claim 1, wherein the second substrate comprises a color filter layer, the color filter layer comprises a plurality of color filter units and a black matrix, the color filter units are alternately arranged with the black matrix.

15. The liquid crystal display panel as claimed in claim 14, wherein the gate lines, data lines, and the thin film transistors are located at the first substrate facing the black matrix.

16. The liquid crystal display panel as claimed in claim 15, wherein the second substrate further comprises a coating layer covering the color filter layer and a common electrode layer covering the coating layer, the common electrode layer is a smooth layer, the spacers contact the common electrode layer.

17. A liquid crystal display panel, comprising:
a thin film transistor substrate;
a color filter substrate disposed generally opposite to the thin film transistor substrate; and
a plurality of step-shaped spacers located at the thin film transistor substrate for supporting the second substrate;
wherein the thin film transistor substrate and the color filter substrates define a consistent cell gap therebetween.

18. The liquid crystal display panel as claimed in claim 17, wherein the thin film transistor substrate comprises a plurality of gate lines, a plurality of data lines, and a plurality of thin film transistors, the spacers are located at the data lines, the gate lines, and the thin film transistors.

19. The liquid crystal display panel as claimed in claim 18, wherein each of the date lines crosses one of the gate lines, the date line together with corresponding gate line and an insulating layer therebetween define a protrusion at the crossing pointion thereof, the spacers comprise first spacers and second spacers, the first spacers are locate at the protrusions, the second spacers are located at the thin film transistors.

20. The liquid crystal display panel as claimed in claim 19, wherein each of the first spacers has a height corresponding to the protrusion, each of the second spacers has a height corresponding to the thin film transistor, a total height of the first spacer and the protrusion is equal to a total height of the second spacer and the thin film transistors.
